(19) United States
(12) Patent Application Publication
(10) Pub. No.: US 2025/0173565 A1
(43) Pub. Date: May 29, 2025

(54) GENERATION DEVICE, GENERATION METHOD, AND GENERATION PROGRAM

(71) Applicant: Hitachi, Ltd., Tokyo (JP)

(72) Inventor: Yohei KAWAGUCHI, Tokyo (JP)

(73) Assignee: Hitachi, Ltd., Tokyo (JP)

(21) Appl. No.: 18/948,035

(22) Filed: Nov. 14, 2024

(30) Foreign Application Priority Data
Nov. 27, 2023 (JP) 2023-200103

(51) Int. Cl. G06N 3/08; G06F 40/205

(52) U.S. Cl. CPC G06N 3/08; G06F 40/205

(57) ABSTRACT

A generation device including a processor for executing a program and a storage device to store the program access a database including a first pre-event signal indicating a state before a change in a first state, a first post-event signal indicating a state after the change in the first state, and a first descriptive text describing states before and after the change by a character string. The processor executes first combining processing of generating first combined data obtained by combining a feature related to the first pre-event signal, a feature related to the first post-event signal, and a first difference between those signals, and training processing of training, based on the first combined data generated by the first combining processing and the first descriptive text, a generation model configured to generate a character string indicating the states before and after the change in the first state.

### CLAIM OF PRIORITY

The present application claims priority from Japanese patent application No. 2023-200103 filed on Nov. 27, 2023, the content of which is hereby incorporated by reference into this application.

### BACKGROUND OF THE INVENTION

### 1. Field of the Invention

The present invention relates to a generation device, a generation method, and a generation program for generating a character string.

### 2. Description of Related Art

It is important to generate, from respective signals obtained under two different conditions, a character string that describes in a natural language what has changed in the signals due to a change in a condition. For example, an abnormality in equipment or a machine or a sign thereof is automatically detected from an operation sound. However, in the presentation of only the presence or absence of the abnormality or the sign, subsequent manual detailed inspections require a lot of man-hours because it is not possible to know where to focus on.

In response to this, when it is possible to automatically and clearly present in the natural language how normal sounds measured in the past differ from current sounds that are determined to be abnormal, a clue is provided for the detailed inspection by an inspector user, and the man-hours are further reduced.

The following NPL 1 discloses a method for generating a character string describing in natural language what has changed between two optical images. The NPL 1 states that “We present a novel Dual Dynamic Attention Model (DUDA) to perform robust Change Captioning. Our model learns to distinguish distractors from semantic changes, localize the changes via Dual Attention over “before” and “after” images, and accurately describe them in natural language via Dynamic Speaker, by adaptively focusing on the necessary visual inputs (e.g., “before” or “after” image)”.

### CITATION LIST

### Non Patent Literature

NPL 1: Dong Huk Park, Trevor Darrell, and Anna Rohrbach, “Robust Change Captioning,” in arxiv, 17 Apr. 2019.

### SUMMARY OF THE INVENTION

In NPL 1, since an optical image is a target, a local change in a limited pixel region, such as movement of an object, is a main detection target. Therefore, what changes are focused on is relatively clear from the image. Here, training data is created by manually assigning a descriptive text character string as a ground truth to two images, one before the change and one after the change, by a person called an annotator. In the case of the optical image, the change to be focused on is relatively clear as described above, and therefore, the annotator can assign an appropriate descriptive text character string. Therefore, appropriate training data can be created, and a generation model for character string generation can be trained based on the training data. Therefore, highly accurate character string generation can be implemented.

However, in the case of a general signal as a target, particularly in the case of a sound or vibration of equipment, a machine, or the like, a component of the general signal is not locally limited in terms of time and frequency, and a change in the general signal also covers the entire signal component, such as the magnitude of a sound volume, the level of a pitch, and new generation or disappearance of a sound source. There are countless changes between the signal before the change and the signal after the change, and therefore, it is not clear what changes are focused on. For this reason, it is not possible to assign a desirable descriptive text unless the annotator knows what to focus on among the countless changes. Therefore, appropriate training data cannot be generated, and even if a generation model for character string generation is trained based on the training data, accurate character string generation cannot be implemented.

An object of the invention is to learn, from respective signals obtained under two different conditions, what has changed between the signals due to a change in a condition in a manner that can be described in natural language. Another object of the invention is to describe, from respective signals obtained under two different conditions, what has changed between the signals due to the change in the condition in a natural language.

A generation device according to one aspect of the invention disclosed in this application includes a processor configured to execute a program, and a storage device configured to store the program. The generation device can access a database including a first pre-event signal indicating a state before a change in a first state, a first post-event signal indicating a state after the change in the first state, and a first descriptive text describing states before and after the change by a character string. The processor executes first combining processing of generating first combined data obtained by combining a feature related to the first pre-event signal, a feature related to the first post-event signal, and a first difference between the feature related to the first pre-event signal and the feature related to the first post-event signal, and training processing of training, based on the first combined data generated by the first combining processing and the first descriptive text, a generation model configured to generate a character string indicating the states before and after the change in the first state.

A generation device according to another aspect of the invention disclosed in this application includes a processor configured to execute a program, and a storage device configured to store the program. The generation device can access a generation model trained to generate a character string indicating states before and after a change in a state. The processor executes second combining processing of generating second combined data obtained by combining a feature related to a second pre-event signal indicating a state before a change in a second state, a feature related to a second post-event signal indicating a state after the change in the second state, and a second difference between the feature related to the second pre-event signal and the feature related to the second post-event signal, and generation processing of generating a character string indicating the states before and after the change in the second state by inputting the second combined data generated by the second combining processing to the generation model.

According to a representative embodiment of the invention, it is possible to learn, from respective signals obtained under two different conditions, what has changed between the signals due to a change in a condition in a manner that can be described in natural language. In addition, from the respective signals obtained under two different conditions, what has changed between the signals due to the change in the condition can be described in a natural language. Problems, configurations, and effects other than those described above will be clarified by descriptions of the following embodiments.

### BRIEF DESCRIPTION OF THE DRAWINGS

FIG. 1 is a block diagram showing a hardware structure example of a generation device;

FIG. 2 is a block diagram showing a functional configuration example of the generation device;

FIG. 3 is a block diagram showing a functional configuration example of a learning unit;

FIG. 4 is a flowchart showing an example of a training processing procedure of the learning unit;

FIG. 5 is a block diagram showing a functional configuration example of a generation unit; and

FIG. 6 is a flowchart showing an example of a generation processing procedure of the generation unit.

### DESCRIPTION OF EMBODIMENTS

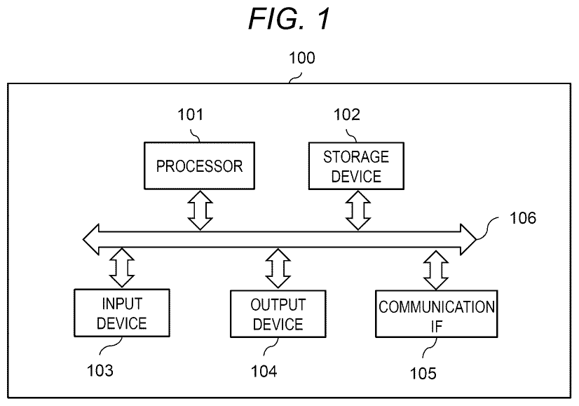

### FIG. 1 Hardware Structure Example of Generation Device

FIG. 1 is a block diagram showing a hardware structure example of a generation device. A generation device 100 includes a processor 101, a storage device 102, an input device 103, an output device 104, and a communication interface (communication IF) 105. The processor 101, the storage device 102, the input device 103, the output device 104, and the communication IF 105 are connected to one another by a bus 106. The processor 101 controls the generation device 100. The storage device 102 is a work area of the processor 101. The storage device 102 is a non-transitory or transitory recording medium that stores various programs or data. Examples of the storage device 102 include a read only memory (ROM), a random access memory (RAM), a hard disk drive (HDD), and a flash memory. The input device 103 inputs data. Examples of the input device 103 include a keyboard, a mouse, a touch panel, a numeric keypad, a scanner, a microphone, and a sensor. The output device 104 outputs data. Examples of the output device 104 include a display, a printer, and a speaker. The communication IF 105 is connected to a network to transmit and receive data.

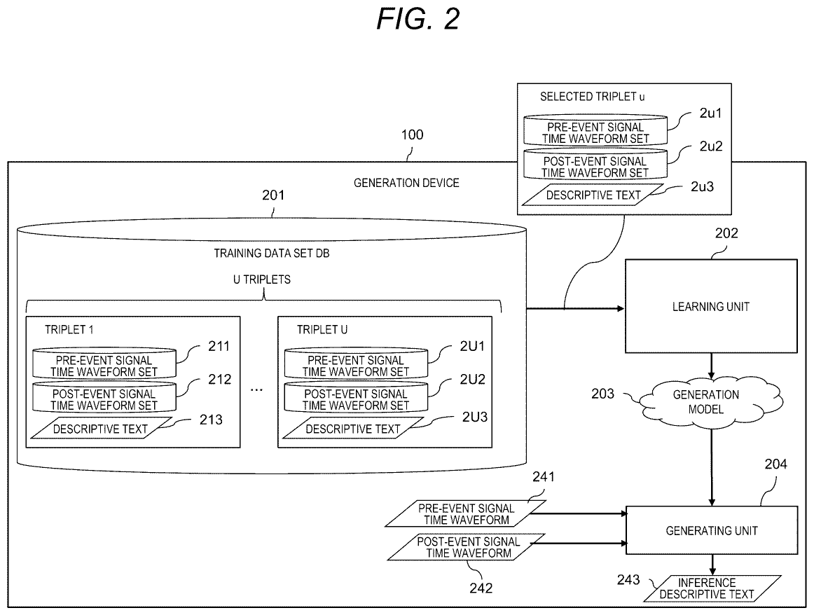

### FIG. 2 Functional Configuration Example of Generation Device 100

FIG. 2 is a block diagram showing a functional configuration example of the generation device 100. The generation device 100 includes a training data set database (DB) 201, a learning unit 202, a generation model 203, and a generation unit 204. Specifically, for example, the training data set DB 201 is stored in the storage device 102 shown in FIG. 1 or another computer capable of communicating with the generation device 100. Specifically, the learning unit 202, the generation model 203, and the generation unit 204 are implemented, for example, by causing the processor 101 to execute a program stored in the storage device 102 shown in FIG. 1.

The training data set DB 201 is a database that stores one or more training data sets. The training data set refers to a combination of training data and ground truth data. The training data set DB 201 has, as a training data set, a set of a triplet u {triplet 1, . . . , triplet u, . . . , triplet U}each including a pre-event signal time waveform set 2u1, a post-event signal time waveform set 2u2, and a descriptive text 2u3.

The pre-event signal time waveform set 2u1 is a set of pre-event signal time waveforms. The pre-event signal time waveform refers to training data indicating a time waveform of a pre-event signal. The pre-event signal is a signal under a condition that a change in a certain state does not occur, for example, a steady sound, a periodic sound, or an aperiodic sound of a device to be inspected.

The post-event signal time waveform set 2u2 is a set of post-event signal time waveforms. The post-event signal time waveform refers to training data indicating a time waveform of a post-event signal. The post-event signal is a signal under a condition that a certain state has changed, for example, an abnormal sound of the device to be inspected that has changed from the steady sound in the state before the change.

When the pre-event signal time waveform and the post-event signal time waveform are not distinguished from each other, they are referred to as signal time waveforms.

The descriptive text 2u3 is a variable-length text including an onomatopoeia representing a change between the pre-event signal waveform and the post-event signal time waveform.

The case of a descriptive text representing a change from a normal state to an abnormal state of a bearing of a rotation body is exemplified as follows. A character string enclosed in a bracket is an onomatopoeia assigned by an annotator.

“The sound was changed from “bo” to “woo”, and the pitch was increased.”

“The sound called “win win” disappeared.”

“The pitch of the sound called “bong” and the sound called “sizzle” increased, and the sound volume increased.”

Here, by instructing the annotator to pay attention to the change, creating a descriptive text expressing the change, and using the descriptive text as the ground truth data of the generation model 203, the generation model 203 can describe how the steady sound and the sound determined to be currently abnormal are different.

The assignment of an onomatopoeia by an annotator is extremely important for providing information that is a clue for detailed inspection by an inspector. This is because, even if the annotator is given only the post-event signal time waveform and asked to answer “what sound is it?” or “what kind of sound is it?”, only a response including information independent of the change, such as simply “sound of bearing”, is obtained.

In addition, there is a problem that a narrative description that does not include an onomatopoeia is unable to express in detail what sounds have changed and how. That is, if there is no expression of an onomatopoeia, not only the generation model 203 cannot express the change in detail, but also a training data set used for training the generation model 203 cannot be created because an annotator cannot describe the change well.

Therefore, by creating a descriptive text including an onomatopoeia in an annotation, the annotator can express in detail what sounds have changed and how. The generation model 203 capable of expressing the change in detail can be implemented by using the descriptive text created accordingly.

It is also possible to cause the annotator to classify the sound (for example, the “sound of a bearing” or the like) rather than using an onomatopoeia. However, such an expression has a tendency to increase the number of appearing words as the number of usage scenes increases, and meanwhile, the increased vocabulary is not used in different scenes. Therefore, it is difficult to acquire a general-purpose model that spans different scenes. Therefore, a general generation model 203 that spans multiple scenes can be acquired by focusing on the fact that an onomatopoeia can be used for general purposes across scenes and creating a descriptive text including an onomatopoeia in an annotation.

The learning unit 202 randomly selects a triplet u from a set including U triplets {triplet 1, . . . , triplet u, . . . , triplet U}. As described above, the triplet u includes the pre-event signal time waveform set 2u1, the post-event signal time waveform set 2u2, and the descriptive text 2u3. In the triplet, the learning unit 202 randomly selects one element from the pre-event signal time waveform set 2u1 and sets the element as a pre-event signal time waveform 301, randomly selects one element from the post-event signal time waveform set 2u2 and sets the element as a post-event signal time waveform 302, sets a combination of the pre-event signal time waveform 301 and the post-event signal time waveform 302 as an explanatory variable, and sets the descriptive text 2u3 as a descriptive text 303 that is an objective variable.

The learning unit 202 trains the generation model 203 using the triplet. For example, the learning unit 202 calculates a value of a loss function based on a difference between the descriptive text 303 and output data output as a result of inputting the set explanatory variable to the generation model 203, and updates parameters of the generation model 203 such that the value of the loss function is minimized.

The generation model 203 is a language model that outputs a descriptive text when a signal time waveform is input. The generation model 203 is trained by the learning unit 202, and an inference descriptive text 243 is generated in the generation unit 204.

The generation unit 204 inputs a pre-event signal time waveform 241 and a post-event signal time waveform 242 to the generation model 203 and outputs the inference descriptive text 243 from the generation model 203. The pre-event signal time waveform 241 may be a pre-event signal time waveform in the pre-event signal time waveform set 211 or may be a pre-event signal time waveform different from the pre-event signal time waveform in the pre-event signal time waveform set 211. The post-event signal time waveform 242 may be a post-event signal time waveform in the post-event signal time waveform set 212 or may be a post-event signal time waveform different from the post-event signal time waveform in the post-event signal time waveform set 212.

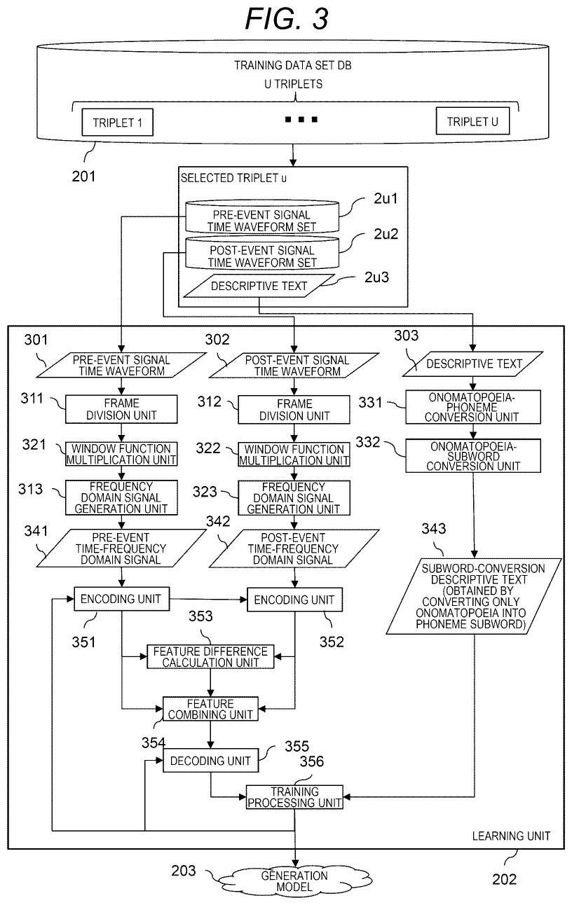

### FIG. 3 Functional Configuration Example of Learning Unit 202

FIG. 3 is a block diagram showing a functional configuration example of the learning unit 202. The learning unit 202 includes frame division units 311 and 312, window function multiplication units 321 and 322, frequency domain signal generation units 313 and 323, encoding units 351 and 352, a feature difference calculation unit 353, a feature combining unit 354, a decoding unit 355, an onomatopoeia-phoneme conversion unit 331, an onomatopoeia subword conversion unit 332, and a training processing unit 356.

The frame division units 311 and 312 divide signal time waveforms into frames. Each of the divided signal time waveforms is referred to as a frame division signal.

The window function multiplication units 321 and 322 perform window function multiplication on the frame division signals to convert each of the frame division signals into a window function multiplication signal.

The frequency domain signal generation units 313 and 323 perform a short-time Fourier transform on each of the window function multiplication signals to transform the window function multiplication signals into time-frequency domain signals. The frequency domain signal generation units 313 and 323 may also use a frequency conversion technique such as a constant Q conversion (CQT) instead of the short-time Fourier transform.

The encoding units 351 and 352 calculate feature vectors based on the frequency domain signals. The encoding units 351 and 352 are typically encoders of a neural network in which a plurality of convolution layers, a plurality of activation functions, and a plurality of pooling layers are stacked and skip connections are interposed therebetween. In addition, the encoding units 351 and 352 may be recurrent neural networks having layers such as a transformer model, a long-short-term-memory (LSTM), a bidirectional LSTM, a gated recurrent unit (GRU), and a bidirectional GRU which are known.

The feature difference calculation unit 353 calculates a difference vector which is a difference between a feature vector from the encoding unit 351 and a feature vector from the encoding unit 352. The difference vector is a feature in which a change is emphasized, and by performing training using the feature, it is possible to generate the generation model 203 that generates a descriptive text in which a change is emphasized.

The feature combining unit 354 combines the feature vector from the encoding unit 351, the feature vector from the encoding unit 352, and the difference vector to generate a combined vector.

The decoding unit 355 receives the combined vector from the feature combining unit 354 as an input, and generates a variable-length text in which a phoneme of an onomatopoeia is converted into a subword, similar to a subword-converted descriptive text 343 described below. The decoding unit 355 is typically a decoder for a known transformer model that is a type of neural network. In addition, the decoding unit 355 may be a recurrent neural network having layers such as a transformer model, a long-short-term-memory (LSTM), a bidirectional LSTM, a gated recurrent unit (GRU), and a bidirectional GRU which are known. The neural network used by the decoding unit 305 is referred to as a decoding model.

The onomatopoeia-phoneme conversion unit 331 extracts a character string enclosed in parentheses from the descriptive text 303 as an onomatopoeia, converts the extracted onomatopoeia into a phoneme string, and generates an onomatopoeia-phoneme converted text. For example, when the onomatopoeia is “clack clack”, the phoneme string is / k a N k a N /. When the onomatopoeia is “rattling and thud”, the phoneme string is / k a t a k a t a d o: N /. Therefore, for example, the example “The pitch of the sound called “bong” and the sound called “sizzle” increased, and the sound volume increased.” in the aforementioned descriptive text 303 is converted into “The pitch of the sound called /b u: N / and the sound called / sh a: / increased, and the sound volume increased”.

The onomatopoeia subword conversion unit 332 performs subword conversion on the onomatopoeia-phoneme converted text. Specifically, for example, the onomatopoeia subword conversion unit 332 outputs a partial character string that is extracted for each predetermined number (n) of characters (the number of grams) while shifting a target range of a phoneme string of the onomatopoeia in the onomatopoeia-phoneme converted text by one character at a time.

For example, when the onomatopoeia is “rattling and thud”, the original phoneme (/ k a t a k a t a d o: N /) is converted into the following phoneme subword (when n=4).
/ k a t a /
/ a t a k /
/ t a k a /
/ a k a t /
/ k a t a /
/ a t a d /
/ t a d o: /
/ a d o: N /

Hereinafter, characters whose number n is equal to 4 in each line are treated as one word. Accordingly, the subword-converted descriptive text 343, obtained by converting only an onomatopoeia into a phoneme subword, is generated.

The effect of the onomatopoeia-subword conversion will be described. The frequency of appearance of an onomatopoeia is sparse compared with that of a normal word. For example, “rattling and thud” rarely appears in other scenes. Therefore, when an onomatopoeia is input to a language model as it is, similar onomatopoeias are completely distinguished as words, so that training data per word is insufficient and training cannot be performed. The subword conversion has an effect of preventing insufficiency of training data by disassembling “/ k a t a k a t a d o: N /” into high-frequency phoneme strings such as “/ k a t a /” and “/ t a k a /”.

The training processing unit 356 compares the variable-length text generated by the decoding unit 355 (here, the phoneme of the onomatopoeia is converted into a subword, similar to the subword-converted descriptive text 343) with the subword-converted descriptive text 343 generated by the onomatopoeia subword conversion unit 332, and updates parameters of each neural network model of the encoding units 351 and 352 and the decoding unit 355 to minimize the following cross entropy L.

$$L = {\sum }_{k = 1}^{K \_ u} {\sum }_{i = 1}^{I\_u} {\sum }_{t = 1}^{T} log [ p ( w ( t ) \vert w\_ 1 : t - 1 , X ] \qquad ( 1 )$$

Here, K_u represents the total number of elements belonging to the pre-event signal time waveform set 2u1, and k represents a number that uniquely identifies the element. I_u represents the total number of elements belonging to the post-event signal time waveform set 2u2, and i represents a number that uniquely identifies the element. T represents the number of words appearing in the subword-converted descriptive text 343. t represents a number that uniquely identifies the word. w(t) represents the probability of correctly estimating the t-th word, and can be calculated by comparing the variable-length text generated by the decoding unit 355 (here, the phoneme of the onomatopoeia is converted into a subword, similar to the subword-converted descriptive text 343) with the subword-converted descriptive text 343. w_1: t−1 represents a sequence of words from t=1 to t=t−1. X represents a combined vector. The optimization can be performed using a known optimization algorithm such as SGD, Momentum SGD, AdaGrad, RMSProp, AdaDelta, or Adam.

A combination of the neural network (encoding model) of the encoding units 351 and 352 and the neural network (decoding model) of the decoding unit 355 in which the parameters have been updated becomes the generation model 203.

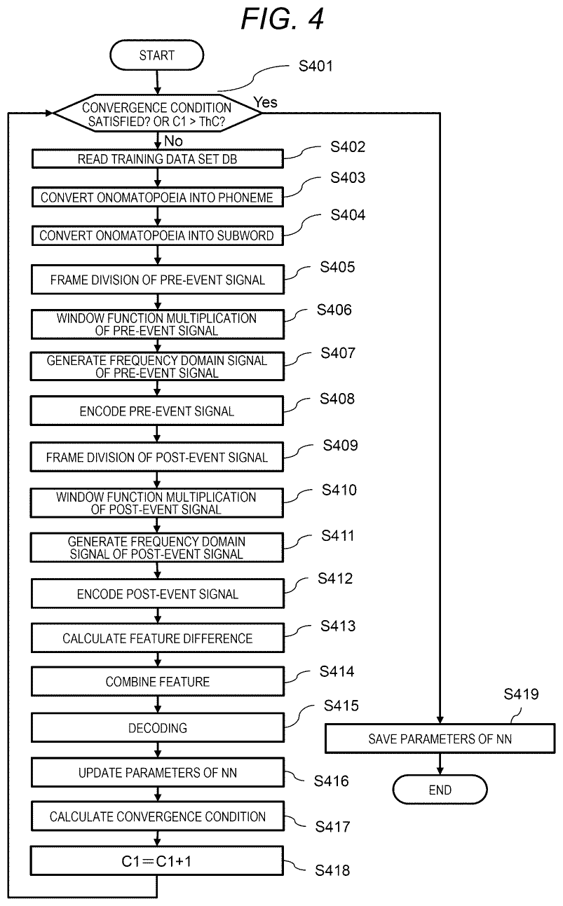

### FIG. 4 Training Processing Procedure of Learning Unit 202

FIG. 4 is a flowchart showing an example of a training processing procedure of the learning unit 202.

### Step S401

The training processing unit 356 determines whether a value of the loss function converges. Specifically, for example, the training processing unit 356 determines whether a convergence determination condition is satisfied or the number of repetitions C1 is larger than a threshold ThC. The convergence determination condition is, for example, a condition that the convergence determination function is smaller than a predetermined threshold.

If the convergence determination condition is not satisfied, and if the number of repetitions C1 is not larger than the threshold ThC (step S401: No), the processing proceeds to step S402. If the convergence determination condition is satisfied, or if the number of repetitions C1 is larger than the threshold ThC (step S401: Yes), it is determined that the value of the loss function has converged, and the processing proceeds to step S419.

### Step S402

The learning unit 202 randomly selects the triplet u from the training data set DB 201. As described above, the triplet u includes the pre-event signal time waveform set 2u1, the post-event signal time waveform set 2u2, and the descriptive text 2u3. In the triplet, the learning unit 202 randomly selects one element from 2u1 and sets the element as a pre-event signal time waveform 301, randomly selects one element from 2u2 and sets the element as a post-event signal time waveform 302, sets a combination of the pre-event signal time waveform 301 and the post-event signal time waveform 302 as an explanatory variable, and sets the descriptive text 2u3 as a descriptive text 303 that is an objective variable.

### Step S403

The onomatopoeia-phoneme conversion unit 331 extracts an onomatopoeia from the descriptive text 303, and converts the extracted onomatopoeia into a phoneme string to generate an onomatopoeia-phoneme converted text.

### Step S404

The onomatopoeia subword conversion unit 332 performs subword conversion on the onomatopoeia-phoneme converted text converted by the onomatopoeia-phoneme conversion unit 331, and generates the subword-converted descriptive text 343.

### Step S405

The frame division unit 311 divides the pre-event signal time waveforms into frames. The frame division signal from the frame division unit 311 is referred to as a pre-event frame division signal.

### Step S406

The window function multiplication unit 321 performs window function multiplication on the pre-event frame division signals and converts each of the pre-event frame division signals into a window function multiplication signal. The window function multiplication signal is referred to as a pre-event window function multiplication signal.

### Step S407

The frequency domain signal generation unit 313 performs a short-time Fourier transform on each of the pre-event window function multiplication signals to transform the pre-event window function multiplication signals into time-frequency domain signals. The time-frequency domain signal is referred to as a pre-event time-frequency domain signal.

### Step S408

The encoding unit 351 calculates a feature vector based on the pre-event frequency domain signal. The feature vector is referred to as a pre-event feature vector.

### Step S409

The frame division unit 312 divides the post-event signal time waveforms into frames. The frame division signal from the frame division unit 312 is referred to as a post-event frame division signal.

### Step S410

The window function multiplication unit 322 performs window function multiplication on the post-event frame division signals and converts each of the post-event frame division signals into a window function multiplication signal. The window function multiplication signal is referred to as a post-event window function multiplication signal.

### Step S411

The frequency domain signal generation unit 323 performs a short-time Fourier transform on each of the post-event window function multiplication signals to transform the pre-event window function multiplication signals into time-frequency domain signals. The time-frequency domain signal is referred to as a post-event time-frequency domain signal.

### Step S412

The encoding unit 352 calculates a feature vector based on the post-event frequency domain signal. The feature vector is referred to as a post-event feature vector.

It should be noted that steps S409 to S412 may be executed in parallel with steps S405 to S408.

### Step S413

The feature difference calculation unit 353 calculates a difference vector which is a difference between the pre-event feature vector and the post-event feature vector.

### Step S414

The feature combining unit 354 combines the pre-event feature vector, the post-event feature vector, and the difference vector to generate a combined vector.

### Step S415

The decoding unit 355 generates a variable-length text based on the combined vector generated in step S414.

### Step S416

The training processing unit 356 updates the parameters of the neural networks of the encoding units 351 and 352 and the decoding unit 355 using Formula (1) described above.

### Step S417

The training processing unit 356 calculates a convergence condition.

### Step S418

The training processing unit 356 increments the number of repetitions C1. Then, the processing returns to step S404.

### Step S419

In the case of Yes in step S404, the training processing unit 356 stores the parameters updated in step S416 in the storage device 102 as the parameters of the generation model 203.

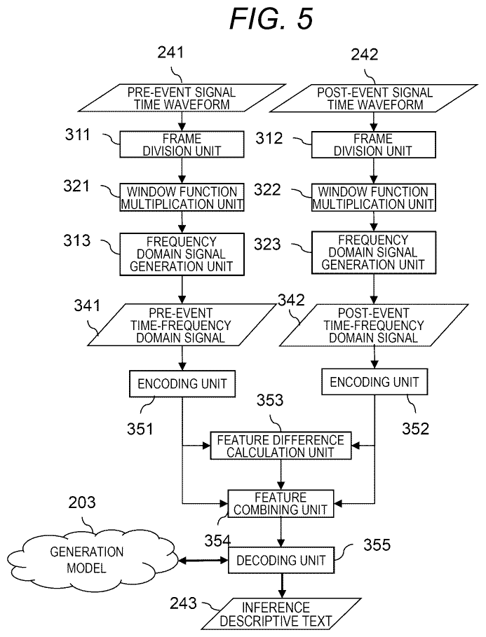

### FIG. 5 Functional Configuration Example of Generation Unit 204

FIG. 5 is a block diagram showing a functional configuration example of the generation unit 204. The generation unit 204 includes the frame division units 311 and 312, the window function multiplication units 321 and 322, the frequency domain signal generation units 313 and 323, the encoding units 351 and 352, the feature difference calculation unit 353, the feature combining unit 354, and the decoding unit 355. That is, a part of the configuration of the learning unit 202 also functions as the generation unit 204.

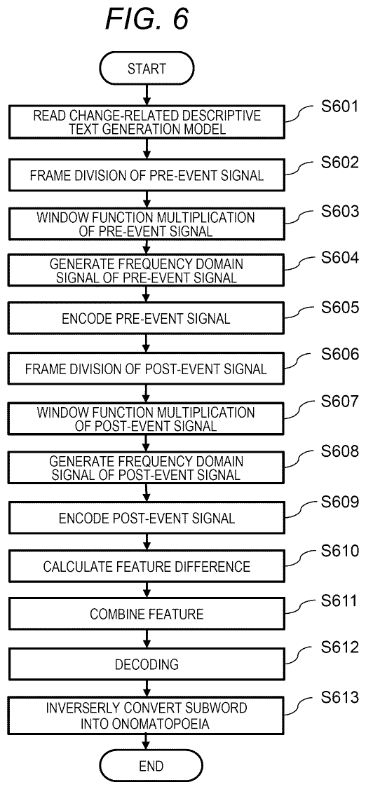

### FIG. 6 Generation Processing Procedure of Generation Unit 204

FIG. 6 is a flowchart showing an example of a generation processing procedure of the generation unit 204.

### Step S601

The generation unit 204 reads the generation model 203.

### Steps S602 to S604

The generation unit 204 executes the same processing as steps S405 to S407 on the input pre-event signal time waveform 241.

### Step S605

The encoding unit 351 calculates a pre-event feature vector based on the pre-event time-frequency domain signal from step S604 using the generation model 203.

### Steps S606 to S608

The generation unit 204 executes the same processing as steps S409 to S411 on the input post-event signal time waveform 242.

### Step S609

The encoding unit 352 calculates a post-event feature vector based on the post-event time-frequency domain signal from step S608 using the generation model 203.

### Step S610

The feature difference calculation unit 353 calculates a difference vector which is a difference between the pre-event feature vector and the post-event feature vector. The difference vector is a feature in which a change is emphasized, and a descriptive text in which a change is emphasized can be generated by performing inference using the feature.

### Step S611

The feature combining unit 354 combines the pre-event feature vector, the post-event feature vector, and the difference vector to generate a combined vector.

### Step S612

The decoding unit 355 uses the generation model 203 to generate a variable-length text including an onomatopoeia subword string with the combined vector as an input.

### Step S613

The decoding unit 355 inversely converts the onomatopoeia subword string in the variable-length text generated in step S612 into the onomatopoeia text via the phoneme string of the onomatopoeia. Accordingly, the variable-length text including the onomatopoeia subword is converted into the final inference descriptive text 243.

First, a description will be given of a method of inversely converting an onomatopoeia subword string of a variable-length text into a phoneme string of an onomatopoeia. During the training (step S403), when the phoneme string of the onomatopoeia is converted into the onomatopoeia subword string, the onomatopoeia subword conversion unit 332 generates an onomatopoeia subword string by shifting the range by one character at a time while overlapping the range by n−1 characters.

In the inverse conversion, the decoding unit 355 extracts a phoneme for an onomatopoeia subword string S=[s 1, . . . , s_M] including M onomatopoeia subwords s_m (m=1, . . . , M) as follows: only v_m1, which is the first character, is extracted for the m-th subword s_m=[v_m1, . . . , v_mn] in the case of m=1, . . . , M−1.

The decoding unit 355 extracts the entire character strings s_M=[v_M1, . . . , v_Mn] for the last subword s_M when m=M. That is, [v_11, v_21, v_31, . . . , v_{M−1}1, v_M1, . . . , v_Mn] are generated as the phoneme string of the onomatopoeia.

Next, in the inverse conversion of the onomatopoeia phoneme string into the onomatopoeia text, there is a one-to-one relationship between a phoneme and a katakana, and therefore, the decoding unit 355 may perform the conversion according to a correspondence table. Accordingly, the onomatopoeia text is restored, and the generation of the entire inference descriptive text 243 is completed.

### Model Switching for Each Type of Focused Signal

The signals observed as the pre-event signal and the post-event signal are roughly classified into three types such as a steady signal, a periodic signal, and an aperiodic signal. Depending on the type of signals, the types of models suitable as models of the encoding units 351 and 352 (hereinafter referred to as encoding models) are different. For example, a network having a spatial attention mechanism is suitable for the steady signal, and the accuracy is higher than the transformer.

The transformer is suitable for the periodic signal and the aperiodic signal, and the accuracy is higher than the network including a spatial attention mechanism. Further, it is more accurate to prepare a separate encoding model for each type of the steady signal, the periodic signal, and the aperiodic signal. The generation device 100 configures the three types of encoding models as generation models 203 as follows. On this premise, the training data set DB 201 is prepared for each type of signal.

The training data set DB 201 for a steady signal includes a pre-event signal time waveform set 211 of a steady signal, a post-event signal time waveform set 212 of a steady signal, and a descriptive text set 213 in which a change between them is described by the annotator. The training data set DB 201 specific to the steady signal can be configured by instructing the annotator to give a description “focus on the steady signal”. Then, the learning unit 202 executes training of the generation model 203 by preparing, as an encoding model, a network including a spatial attention mechanism and suitable for a steady signal as described above.

The training data set DB 201 for the periodic signal includes a pre-event signal time waveform set 211 of a periodic signal, a post-event signal time waveform set 212 of the periodic signal, and a descriptive text set 213 in which a change between the pre-event signal time waveform set 211 and the post-event signal time waveform set 212 is described by the annotator. The training data set DB 201 specific to the periodic signal can be configured by instructing the annotator to give a description “focus on the periodic signal”. Then, the learning unit 202 executes training of the generation model 203 by preparing a transformer suitable for the periodic signal as an encoding model as described above.

The training data set DB 201 for the aperiodic signal includes a pre-event signal time waveform set 211 of the aperiodic signal, a post-event signal time waveform set 212 of the aperiodic signal, and a descriptive text set 213 in which a change between them is described by the annotator. The training data set DB 201 specific to the aperiodic signal can be configured by instructing the annotator to give a description “focus on the aperiodic signal”. Then, the learning unit 202 executes training of the generation model 203 by preparing a transformer suitable for an aperiodic signal as an encoding model as described above.

The generation unit 204 switches and uses the three types of generation models 203 described above. For example, in a usage scene which is known to be focused on a specific type of signal, the generation model 203 of this type is specified and executed to generate the inference descriptive text 243 with high accuracy by specializing the signal of the specified type and without being adversely affected by other noises.

The generation unit 204 may use the above three types of generation models 203 simultaneously in parallel. For example, it is possible to add a character string of “for a steady signal” to the beginning of the inference descriptive text 243 output from the generation model 203 for a steady signal, add a character string of “for a periodic signal” to the beginning of the inference descriptive text 243 output from the generation model 203 for a periodic signal, add a character string of “for an aperiodic signal” to the beginning of the inference descriptive text 243 output from the generation model 203 for an aperiodic signal, and connect and output these three descriptive texts separately. Accordingly, the user can simultaneously read the description from a plurality of viewpoints corresponding to the three types of generation models 203, and therefore, there is an effect that it is easy to compare different viewpoints and gain new insights.

Here, the point in which the generation unit 204 executes three types of generation models 203 in parallel has been described as an example, and the generation unit 204 may execute two types of generation models 203 among the three types of generation models 203 in parallel. When there are signals other than the three types described above, the generation unit 204 may execute four or more types of generation models 203 in parallel.

As described above, the two conditions are set as A and B, with respect to a set S_A and a set S_B including one or more sample signals respectively corresponding to the condition A (for example, normal time (pre-event)) and the condition B (for example, abnormal time (post-event)), the annotator assigns a character string C for describing the difference between the set S_A and the set S_B, and the triplet set of the set S_A, the set S_B, and the character string C is set as the training data set.

During training, the generation device 100 inputs the elements of the set S_A and the set S_B and trains the generation model 203 to output the character string C. During inference, the generation device 100 generates the inference descriptive text 234 from each signal of the condition A and the condition B using the generation model 203.

An annotator who does not know what to focus on among the countless changes is likely to describe mere outliers rather than significant changes when comparing signal samples one-to-one. In contrast, in the present embodiment, even when the annotator does not have specialization, it is possible to find a significant change between the condition A and the condition B and provide the character string C regardless of the outlier by comparing the samples in a plurality of different pairs of different conditions.

Therefore, for example, the learning unit 202 repeatedly selects a combination of the pre-event signal time waveform and the post-event signal time waveform from the triplet u selected as the training data set generated as described above, and trains the generation model 203 using the combined vector repeatedly generated for each selected combination and the descriptive text 2u3. Accordingly, during inference using the generation model 203, the generation unit 204 can generate the inference descriptive text 234 focusing on significant changes due to changes in the condition A and the condition B.

As described above, even if the annotator does not know in advance what should be focused on among countless changes, the generation device 100 described above can learn or infer what has changed between signals due to a change in the conditions in a natural language from the signals obtained under two different conditions. Accordingly, the annotator can easily specify what is to be focused on among countless changes.

In the embodiment described above, the generation device 100 includes the learning unit 202 and the generation unit 204. Alternatively, the generation device 100 may include either the learning unit 202 or the generation unit 204, and the other may be provided in another computer capable of communicating with the generation device 100.

Further, a sound signal is described as an example in the embodiment described above, and the same method can be used for a signal from an ultrasonic sensor. In addition, the same configuration can also be used for general time-series signals such as time waveforms of acceleration sensors and displacement sensors, time waveforms of current sensors, and financial indicators such as stock prices and exchange rates. In the case of the time waveforms of current sensors, the financial indicators such as stock prices and exchange rates, and the like, not an “onomatopoeia” but a “mimetic word” is used, and such an onomatopoeia or a mimetic word can be applied to the onomatopoeia-phoneme conversion unit 331 and the onomatopoeia subword conversion unit 332 as onomatopoeias.

The invention is not limited to the above embodiments, and includes various modifications and equivalent configurations within the scope of the appended claims. For example, the above embodiment is described in detail for easy understanding of the invention, and the invention is not necessarily limited to those including all the configurations described above. A part of a configuration of one embodiment may be replaced with a configuration of another embodiment. A configuration of one embodiment may also be added to a configuration of another embodiment. Another configuration may be added to a part of a configuration of each embodiment, and a part of the configuration of each embodiment may be deleted or replaced with another configuration.

A part or all of the above configurations, functions, processing units, processing methods, and the like may be implemented by hardware by, for example, designing with an integrated circuit, or may be implemented by software by, for example, a processor interpreting and executing a program for implementing each function.

Information on such as a program, a table, and a file for implementing each function can be stored in a storage device such as a memory, a hard disk, or a solid state drive (SSD), or in a recording medium such as an integrated circuit (IC) card, an SD card, or a digital versatile disc (DVD).

Control lines and information lines considered to be necessary for description are illustrated, and not all control lines and information lines necessary for implementation are illustrated. Actually, it may be considered that almost all the configurations are connected to one another.

1. A generation device comprising:
a processor configured to execute a program; and
a storage device configured to store the program, wherein
a database is accessible, the database including a first pre-event signal indicating a state before a change in a first state, a first post-event signal indicating a state after the change in the first state, and a first descriptive text describing states before and after the change by a character string, and
the processor executes
first combining processing of generating first combined data obtained by combining a feature related to the first pre-event signal, a feature related to the first post-event signal, and a first difference between the feature related to the first pre-event signal and the feature related to the first post-event signal, and
training processing of training, based on the first combined data generated by the first combining processing and the first descriptive text, a generation model configured to generate a character string indicating the states before and after the change in the first state.

2. The generation device according to claim 1, wherein
the processor executes first encoding processing of outputting the feature related to the first pre-event signal and the feature related to the first post-event signal by separately inputting the first pre-event signal and the first post-event signal to an encoding model configured to encode a signal and output a feature related to the signal, and
in the first combining processing, the processor generates the feature related to the first pre-event signal output by the first encoding processing, the feature related to the first post-event signal output by the first encoding processing, and the first combined data.

3. The generation device according to claim 2, wherein
the processor executes first decoding processing of outputting a first decoding descriptive text based on a difference between the first pre-event signal and the first post-event signal by inputting the first combined data to a decoding model configured to output a variable-length text when a feature is input, and
in the training processing, the processor trains the generation model that is the encoding model and the decoding model based on the first descriptive text and the first decoding descriptive text that is output by the first decoding processing.

4. The generation device according to claim 1, wherein
the processor executes subword conversion processing of generating a plurality of subwords based on a specific character string in the first descriptive text and generating a plurality of the first descriptive texts, and
in the training processing, the processor trains the generation model based on the first combined data and the plurality of first descriptive texts generated by the subword conversion processing.

5. The generation device according to claim 1, wherein
the processor executes
second combining processing of generating second combined data obtained by combining a feature related to a second pre-event signal indicating a state before a change in a second state, a feature related to a second post-event signal indicating a state after the change in the second state, and a second difference between the feature related to the second pre-event signal and the feature related to the second post-event signal, and
generation processing of generating a character string indicating the states before and after the change in the second state by inputting the second combined data generated by the second combining processing to the generation model.

6. The generation device according to claim 5, wherein
the processor executes second encoding processing of outputting the feature related to the second pre-event signal and the feature related to the second post-event signal by separately inputting the second pre-event signal and the second post-event signal to an encoding model configured to encode a signal and output a feature related to the signal, and
in the second combining processing, the processor generates the feature related to the second pre-event signal output by the second encoding processing, the feature related to the second post-event signal output by the second encoding processing, and the second combined data.

7. The generation device according to claim 6, wherein
the processor executes second decoding processing of outputting a second decoding descriptive text based on a difference between the second pre-event signal and the second post-event signal as a character string indicating the states before and after the change in the second state by inputting the second combined data to a decoding model configured to output a variable-length text when a feature is input.

8. The generation device according to claim 1, wherein
the first descriptive text includes, in the states before and after the change, onomatopoeias before and after the change.

9. The generation device according to claim 1, wherein
the database stores a pre-event set having the plurality of first pre-event signals and a post-event set having the plurality of first post-event signals, and
in the first combining processing, a combination of the first pre-event signal and the first post-event signal is repeatedly selected from the pre-event set and the post-event set, and the first combined data is generated for each selected combination of the first pre-event signal and the first post-event signal.

10. The generation device according to claim 1, wherein
the database stores a plurality of types of the first pre-event signals and first post-event signals,
the processor generates the first combined data for each of the plurality of types in the first combining processing, and
the processor trains the generation model for each of the types in the training processing.

11. The generation device according to claim 10, wherein
the plurality of types include at least two types of a steady signal, a periodic signal, and a non-periodic signal.

12. A generation device comprising:
a processor configured to execute a program; and
a storage device configured to store the program, wherein
a generation model trained to generate a character string indicating states before and after a change in a state is accessible, and
the processor executes
second combining processing of generating second combined data obtained by combining a feature related to a second pre-event signal indicating a state before a change in a second state, a feature related to a second post-event signal indicating a state after the change in the second state, and a second difference between the feature related to the second pre-event signal and the feature related to the second post-event signal, and
generation processing of generating a character string indicating the states before and after the change in the second state by inputting the second combined data generated by the second combining processing to the generation model.

13. The generation device according to claim 12, wherein
the generation model is accessible for each of the plurality of types of second pre-event signals and second post-event signals,
the processor generates the second combined data for each of the types in the second combining processing, and
in the generation processing, the processor generates the character string by inputting the second combined data to the generation model for each of the types and outputs a character string in which the character strings for each of the types are distinguished and connected.

14. The generation device according to claim 13, wherein
the plurality of types include at least two types of a steady signal, a periodic signal, and a non-periodic signal.

15. A generation method executed by a generation device including a processor configured to execute a program, and a storage device configured to store the program, a generation model trained to generate a character string indicating states before and after a change in a state being accessible, the method comprising:
second combining processing of generating, by the processor, second combined data obtained by combining a feature related to a second pre-event signal indicating a state before a change in a second state, a feature related to a second post-event signal indicating a state after the change in the second state, and a second difference between the feature related to the second pre-event signal and the feature related to the second post-event signal, and
generation processing of generating, by the processor, a character string indicating the states before and after the change in the second state by inputting the second combined data generated by the second combining processing to the generation model.

16. A generation program for causing a processor, which is configured to access a generation model trained to generate a character string indicating states before and after a change in a state, to execute
second combining processing of generating second combined data obtained by combining a feature related to a second pre-event signal indicating a state before a change in a second state, a feature related to a second post-event signal indicating a state after the change in the second state, and a second difference between the feature related to the second pre-event signal and the feature related to the second post-event signal, and
generation processing of generating a character string indicating the states before and after the change in the second state by inputting the second combined data generated by the second combining processing to the generation model.
